(19) United States
(12) Patent Application Publication
(10) Pub. No.: US 2015/0339461 A1
(43) Pub. Date: Nov. 26, 2015

(54) PRESENCE-BASED CONTENT RESTRICTION

(71) Applicant: EBAY INC., San Jose, CA (US)

(72) Inventors: Eric Byungho Min, San Jose, CA (US); Prakash Chandra, San Jose, CA (US)

(21) Appl. No.: 14/286,502

(22) Filed: May 23, 2014

(51) Int. Cl. G06F 21/10; G06F 21/62

(52) U.S. Cl. CPC G06F 21/10; G06F 21/62; G06F 2221/0731

(57) ABSTRACT

Systems and methods are provided for enforcing content restrictions. The provided systems and methods may include receiving presence data for a user associated with an electronic mobile device, where the presence data indicates a location of the user in a known area, receiving an identification of content either being accessed or requested to be accessed in the known area, accessing a store of policy data, the policy data including an identification of particular items of content and use restrictions thereon, identifying an applicable restriction on the content, the applicable restriction being selected from the store of policy data based on one or more of the presence data and the identification of content, and applying the applicable restriction on content in the known area.

### BACKGROUND

Embodiments disclosed herein are related to systems, methods, and computer program products for applying content restrictions based upon electronically-generated presence data.

Content restrictions are currently widely used. For example, some documents or databases may be designated for viewing by certain people with all others prohibited. Some companies may designate documents for projects to be viewed by people on their own respective projects. Additionally, movies are rated based on maturity level of the content.

Enforcement of content restrictions can be a challenge. Documents can be labeled TOP SECRET or CONFIDENTIAL, but labeling usually relies on the honesty of others to protect the restricted nature of the document. Electronic documents may be stored in databases that require authorization and/or authentication before a user can access a given document. However, electronic databases can be hacked or otherwise compromised, thereby rendering the protections worthless. Also, a user reading a restricted document may provide an over-the shoulder reader a chance to visually snoop.

Another enforcement issue is seen with multimedia content, such as television shows and movies. Some content may be clearly unsuitable for children, and appropriate ratings are often applied as warning or indication of the amount or degree of unsuitability. For instance, a rating of TV-MA is often used for adult-themed television content in the US, and a similar R or NC-17 rating is applied to adult-themed movies. Some televisions and set top boxes allow adults to block television shows based on a rating thereof, and movie theatres may screen ticket buyers for age. New techniques for content restriction would be desirable.

### BRIEF DESCRIPTION OF THE FIGURES

FIG. 1 is a block diagram of a networked system, consistent with some embodiments.

FIG. 2 is a diagram illustrating a computing system, consistent with some embodiments.

FIG. 3 is a diagram illustrating a beacon, consistent with some embodiments.

FIG. 4 is a diagram illustrating a location having multiple beacons throughout the location.

FIG. 5 is a diagram illustrating a first flow for enforcing content restrictions, consistent with some embodiments.

FIG. 6 is a diagram illustrating a second flow for enforcing content restrictions, consistent with some embodiments.

FIG. 7 is a flowchart illustrating a process for providing a proximity-based visual advertisement or notification, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Various embodiments provide systems, methods, and computer program products allowing for new and effective ways to enforce content restrictions. For instance, one embodiment employs a short-range communication technology, such as Bluetooth, Bluetooth Low Energy (BLE), or Near Field Communication (NFC) to identify human users, where a user's handheld device may be considered a proxy for the human user. As a human user moves about a space, beacon devices (e.g., devices employing one or more short-range communication technologies) communicate with the user's handheld device to identify the human user, thereby establishing presence, and provide proximity and/or geographic location of the user. A computer system receives the data and tracks the user.

Additionally, the computer system has access to policy information that indicates specific users or classes of user and content restrictions associated with those users. An example may include a database of user content restrictions. The computer system may compare presence information with the policies to identify any restrictions that are applicable to the particular user. An example policy may indicate that user A is not allowed to see certain confidential documents. Another example policy may indicate that certain television shows or movies cannot be accessed unless user A is present.

Consistent with some embodiments, one example use case includes a short-range communication system that provides data privacy and security by suppressing display of sensitive information. Prior systems that only restrict access to sensitive files may fail to adequately protect data in cases where an authorized user carelessly allows unauthorized viewers opportunities to view his computer system display. This example system suppresses display of sensitive data in cases where unauthorized individual are detected to be present.

Continuing with the use case, user B is an attorney working in an open office area. His workplace employs a short-range communication system throughout the workplace, and individuals are equipped with devices that communicate with beacons placed around the office. User B begins to review a sensitive document at his open, low wall cubicle. The document relates to “Project Mayhem,” and includes metadata indicating that it is viewable only by individuals with Project Mayhem access. User B has the requisite access, and therefore is allowed to open the document on his computer after having logged in with correct credentials. The workplace beacon devices detect that user A approaches user B's cubicle. The system is aware of user A's presence and searches a policy store for restrictions that are applicable to user A with respect to project Mayhem documents. The system determines, based on its search of the policy store, that user A has Project Mayhem access too, and therefore display of the sensitive document on user B's computer is not affected.

Still continuing with the use case, subsequently, the workplace beacon devices detect that user C is at user A's cubicle and search the policy store for restrictions relating to user C with respect to Project Mayhem. The system determines from the policy store that user C does not have Project Mayhem access. Accordingly, user B's computer system suppresses display of the sensitive document (e.g., blocking a portion of the display, obfuscating a portion of the display, disabling the display device). In the case described above, the workplace employs the beacon devices to communicate with the users' respective handheld devices (or badges, or other appropriately compatible communication devices) to determine that user A and user C are within a probable viewing distance of user B's computer screen. The system then either allows display or restricts display of restricted documents based on the determined presence. The system may also, or in the alternative, notify user B, such as on user B's computer or mobile device, that an unauthorized (or authorized) user is approaching so that user B can be informed and take action if needed, such as taking the restricted content off user B's computer screen.

In one example, and enterprise server handling the workplace documents receives the presence data, accesses the store of policy data, and enforces the restriction. In another example, such functionality may be embodied in an application on user B's computer.

In another use case, user X is browsing an e-commerce website at his home. User X begins to shop for a surprise present for his wife, user Y. User X shops in the jewelry section of the e-commerce website, and he indicates that during this session his activity on the jewelry section should be private (e.g., private from user Y, private from all individuals other that user X). User X may employ a browser extension, application, or other appropriate logic module to provide the indication. The browser extension, application, or other logic module works with a short-range communication utility of the computer to track presence of users. For instance, a beacon device may utilize a short-range communication protocol to detect handheld devices of other users in the immediate area, and an application on user X's computer may track presence of other users and compare presence data to entries in the policy store.

The beacon device (e.g., connected to a USB port on the computer, built into the computer, or active on user X's smartphone and communicating with the computer) detects that user Y is approaching. The beacon may actively communicate with and/or passively detect user Y's handheld device and thereby establishes presence of user Y. The computer compares user Y's presence to a policy—in this, case, that the jewelry section should be private from user Y. In response, the computer suppresses display of the jewelry section web page, and in some cases may proceed to substitute a web page showing some other product (e.g., diapers) in order to conceal the intended surprise gift.

In yet another use case, a smart television, set top box, or other computing device controls access to television and movie content by determining whether an authorized user (e.g., and adult) is present, and allowing content based thereon. Once again, a handheld device or other device acts as a proxy for the adult. The smart television, set top box, or other computing device detects presence via use of short-range communication devices, compares presence data to content policies, and either allows or denies access to the content based on the comparing. Thus, in one example, beacon devices monitor the presence of adults in a room such that a smart television, set top box, or other computing device will not allow the display of certain movies unless an (or a particular adult such as a parent) is in the room.

Such use cases may be applied to a home or hotel room to prevent viewing of unsuitable shows by some people (e.g., children). The embodiment may be extended to public places, such as restaurants, so that when presence of a customer is detected (e.g., where that customer has indicated a preference for family content over adult-oriented content) the public place can change or not change content on display devices accordingly.

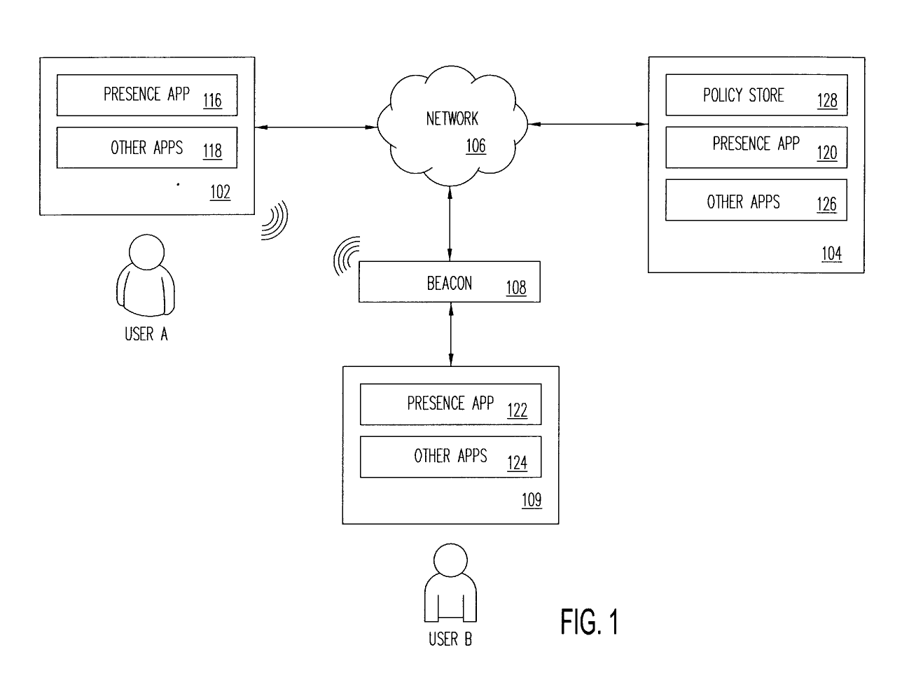

FIG. 1 is a block diagram of a networked system 100, consistent with some embodiments. System 100 includes a mobile computing device 102 and a remote server 104 in communication over a network 106. Mobile computing device 102 is associated with user A in this example. Remote server 104 in this example may be maintained by an entity with which sensitive documents and information may be exchanged with mobile computing device 102—an enterprise document server with sensitive documents. Remote server 104 may be maintained by a web site, an online content manager, or other entity who provides potentially restricted content to a user.

Network 106, in one embodiment, may be implemented as a single network or a combination of multiple networks. For example, in various embodiments, network 106 may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet.

Mobile computing device 102, in one embodiment, may be implemented using any appropriate combination of hardware and/or software configured for wired and/or wireless communication over network 106. For example, mobile computing device 102 may be implemented as a wireless telephone (e.g., smart phone), tablet, notebook computer, personal computer, a head-mounted display (HMD) or other wearable computing device, including a wearable computing device having an eyeglass projection screen or a smart watch, and/or various other generally known types of computing devices.

As shown in FIG. 1, system 100 may include one or more beacons 108 coupled to one or more display computing devices 109. In some embodiments, beacons 108 may be installed at a store, restaurant, office, hotel, and/or the like. Beacons 108 provide short-range communications with devices 102 and 109. An example of a short-range communication protocol includes Bluetooth™ Low Energy (BLE), which may be used with beacons 108 in some examples. BLE is a technology may transmit information at a frequency of about 2.4 GHz (about 2042-2480 MHz) over forty (40) 2-MHz wide channels, and may have a range of about 50 meter or about 160 feet. Information transmitted according to the BLE protocol may be transmitted at a rate of about 1 Mbit/s with an application throughput of about 0.27 Mbit/s. In some embodiments, BLE communications may be secured using 128-bit Advanced Encryption Standard (AES) encryption with counter mode with a cipher block chaining message authentication code (CBC-MAC) and user defined security. Further, in some embodiments, BLE communications may utilize adaptive frequency hopping, lazy acknowledgement, a 24-bit cyclic redundancy check (CRC) and 32-bit message integrity check for robustness. Moreover, in some embodiments, BLE-capable devices may consume a fraction of the power of standard Bluetooth® devices due to the protocol allowing low duty cycles, and being designed for applications that may not require continuous data transfer.

Another example of a short-range communication technique is Near Field Communication (NFC). Various embodiments may be adapted for use with any short-range communication technology that uses wireless protocols to communicate with devices over a range of a few meters to cover a room, an office, a store, or the like. For instance, beacons 108 may be capable of sending and receiving information according to other short-range wireless communications protocols, such as Wi-Fi™, ZigBee®, ANT or ANT+, radio frequency identification (RFID), and other such protocols that have a limited range capable of localizing user A to a known area.

Beacons 108 may transmit one or more sequences of information such that when a device such as mobile computing device 102 capable of receiving information from beacons 108 comes within the range of a beacon 108, the device may receive a transmission from a beacon 108. Beacons 108 may also be capable of receiving one or more sequences of information (e.g., according to the BLE communications protocol) from mobile computing device 102. In some embodiments, beacon 108 may be in communication with remote server 104 over network 106 through wireless or wired connection.

In this example, display computing device 109 is associated with user B. Display computing device 102, in one embodiment, may be implemented using any appropriate combination of hardware and/or software configured for wired and/or wireless communication over network 106. For example, display computing device 102 may be implemented as a wireless telephone (e.g., smart phone), tablet, personal digital assistant (PDA), notebook computer, personal computer, a connected set-top box (STB) such as provided by cable or satellite content providers, a smart television, a video game system console, a head mounted display (HMD) or other wearable computing device, including a wearable computing device having an eyeglass projection screen, and/or various other generally known types of computing devices.

Display computing component 109 may include any apparatus capable of displaying content to user A, wherein the content may include, e.g., a document, a web page, television or movie content, music, and/or the like. In some embodiments, display component 109 may include a monitor such as a liquid crystal display (LCD) screen, an organic light emitting diode (OLED) screen (including active matrix AMOLED screens), an LED screen, a plasma display, a cathode ray tube (CRT) monitor, or an electronic ink (e-Ink) display. In some embodiments, display computing device 109 may include a projection device capable of projecting visual content for viewing by user A, such as a Digital Light Processing (DLP) projector, a laser beam-steering (LBS) projector, a liquid crystal on silicon (LCoS) projector, a mobile or portable projector.

Display computing device 109 may be coupled to beacon 108 directly and/or through network 106. In some embodiments, display computing device 109 may be coupled to beacon 108 via a wired or wireless coupling. In some embodiments, display computing device 109 may be coupled to beacon 108 via a plug in coupling with beacon 108 plugging into a port, such as a Universal Serial Bus (USB) port, a High Definition Multimedia Interface (HDMI) port, and the like on display computing device 109, or vice versa. In further embodiments, display computing device 109 may be coupled to beacon 108 via a bus such that display computing device 109 and beacon 108 are part of the same device, such as a beacon having display or projection abilities.

Thus, in one embodiment, display computing device 109 is a personal computer in use by user B and accessing and displaying documents that are retrieved from server 104. In another embodiment, display computing device 109 is a set top box or smart television that implements restriction of content for television and movies. Beacon 108 may be implemented as a stand-alone device or may be connected to device 109 or server 104 as a dongle or other USB-connected device. Alternatively, a beacon 108 may be built into device 109 and/or server 104.

Mobile computing device 102 may include any appropriate combination of hardware and/or software having one or more processors and capable of reading instructions stored on a tangible non-transitory machine-readable medium for execution by the one or more processors. Consistent with some embodiments, mobile computing device 102 includes a machine-readable medium, such as a memory (not shown) that includes instructions for execution by one or more processors (not shown) for causing mobile computing device 102 to perform specific tasks. In some embodiments, the instructions may be executed by the one or more processors in response to interaction by user A.

Mobile computing device 102 includes a presence application 116 that may be used by system 100 to detect the presence of user A within a known area. In some embodiments, presence application 116 is configured to communicate with beacon 108 to identify itself. Beacon 108 receives data from presence application 116 and passes it to presence application 122 and/or presence application 120. Either or both of applications 120, 122 may then determine presence of user A by, e.g., matching data from application 116 to identifying information in a database (not shown). In any event, logic within either or both of applications 120, 122 uses detected information from beacon 108 to identify that user A is present within a known area. Similarly, when user A leaves the known area, and beacon 108 does not receive signals from device 102, applications 120, 122 may determine that user A is not present in the known area.

Mobile computing device 102 may include other applications 118 as may be desired in one or more embodiments to provide additional features available to user A, including accessing a user account with remote server 104 or other network resource (not shown). For example, applications 118 may include interfaces and communication protocols that allow the user to receive and transmit information through network 106 and to remote server 104 and other online sites. Applications 118 may also include security applications for implementing client-side security features, programmatic client applications for interfacing with appropriate APIs over network 106 or various other types of generally known programs and/or applications. Applications 116 may include mobile applications downloaded and resident on mobile computing device 102 that enables user A to access content through the applications.

Display computing device 109 may include any appropriate combination of hardware and/or software having one or more processors and capable of reading instructions stored on a tangible non-transitory machine-readable medium for execution by the one or more processors. Consistent with some embodiments, display computing device 109 includes a machine-readable medium, such as a memory (not shown) that includes instructions for execution by one or more processors (not shown) for causing display computing device 109 to perform specific tasks. In some embodiments, the instructions may be executed by the one or more processors in response to interaction by user B.

For example, such instructions may include presence application 122, which receives information from beacon 108 and/or server 104 to identify people within the known area and to restrict content as appropriate. In this example, the logic to compare presence information to stored policies is shown as residing at server 104. Thus, in this example, presence application 120 identifies presence of user A through information from beacon 108. Application 120 then compares the presence information to the policies saved in policy store 128. If a policy indicates a content restriction for user A, then presence application 120 causes server 104 to enforce the policy by either sending or not sending restricted content to display computing device 109 or to send instructions to presence application 122 to either display or not display the content at display computing device 109. In such an embodiment, application 122 is a client application that receives information and instruction from application 120. According to one embodiment, server 104 may be an enterprise server that tracks user presence throughout the office and restricts content display device 109 based on detected user presence and policies in policy store 128.

In another example, display device 109 may be a set top box or smart television in a hotel, restaurant, store, or other location and controlled by application 120. Thus, content display at device 190 is restricted based on detected user presence and policies.

Of course, the scope of embodiments is not limited to the use of a physical server or server application separate from the display device 109. For example, other embodiments may include logic to detect presence, access policies, and either display or not display content at device 109 without relying upon input from server 104. Such embodiments may thus employ application 122 to access policy store 128 either at device 109 or remotely from device 109. Put another way, content restriction logic may implemented at a server (such as server 104 in FIG. 1), at a client (such as display computing device 109), or distributed between a server and client as appropriate. The scope of embodiments is not limited to a client/server architecture.

Display computing device 109 also includes other applications 124. Examples of other applications 124 include a browser application, which may be used to provide a user interface to permit user B to browse information available over network 106, including information hosted by remote server 104. For example, browser application 115 may be implemented as a web browser to view information available over network 106. Browser application 115 may include a graphical user interface (GUI) that is configured to allow user A to interface and communicate with remote server 104 or other servers managed by content providers or merchants via network 106. For example, user A may be able to access websites to find and purchase items, as well as access user account information or web content. Other applications 124 may include general office software (e.g., a word processor program, a spreadsheet program, etc.), media streaming applications, and/or the like. In one example, one or more applications in other application 124 are responsible for accessing and displaying content, and application 120 restricts access to that content either by cooperating with other applications 124 or obscuring a display without communicating with other applications 124.

Remote server 104, according to some embodiments, may be implemented using any appropriate combination of hardware and/or software configured for wired and/or wireless communication over network 106. For example, server 104 may be implemented as a commodity server running an operating system, such as Linux upon which applications 120 and 126 run. Server 104 may be implemented as a media server, such that other applications 126 include programs to stream media to clients, or as a file server that provides files to clients. In one example, server 104 is an enterprise server that hosts document management programs. In another example, server 104 is a media server, such as a web server or a media streaming server, to serve content to clients.

Although discussion has been made of applications and applications on mobile computing device 102 and remote server 104, the applications may also be, in some embodiments, modules. Module, as used herein, may refer to a software module that performs a function when executed by one or more processors or Application Specific Integrated Circuit (ASIC) or other circuit having memory and at least one processor for executing instructions to perform a function, such as the functions described as being performed by the applications.

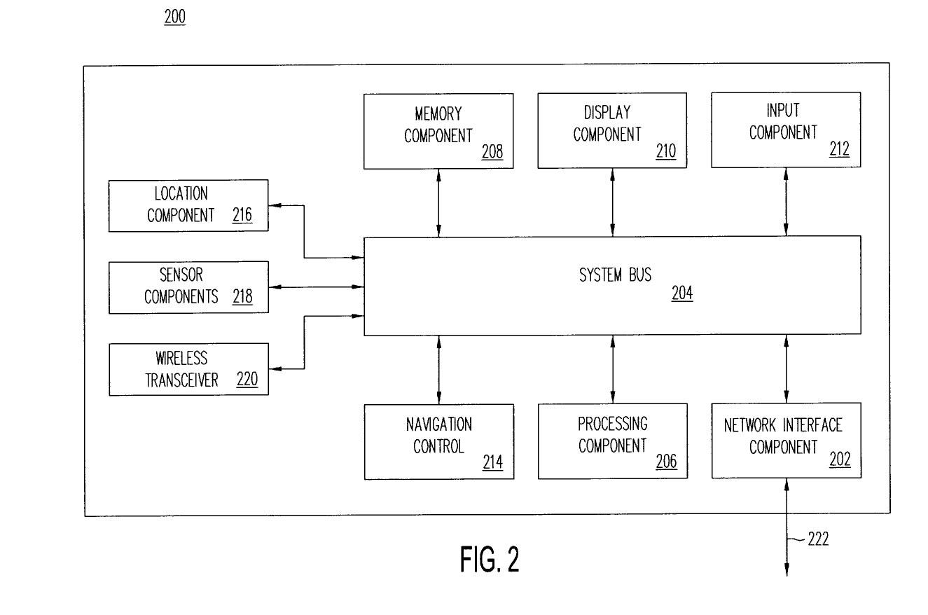

FIG. 2 is a diagram illustrating computing system 200, which may correspond to either of mobile computing device 102, remote server 104, or display computing device 109 consistent with some embodiments. Computing system 200 may be a mobile device such as a smartphone, a tablet computer, a personal computer, laptop computer, netbook, or tablet computer, set-top box, video game console, head-mounted display (HMD) or other wearable computing device as would be consistent with mobile computing device 102. Further, computing system 200 may also be a server or one server amongst a plurality of servers, as would be consistent with remote server 104. As shown in FIG. 2, computing system 200 includes a network interface component (NIC) 202 configured for communication with a network such as network 106 shown in FIG. 1. Consistent with some embodiments, NIC 202 includes a wireless communication component, such as a wireless broadband component, a wireless satellite component, or various other types of wireless communication components including radio frequency (RF), microwave frequency (MWF), and/or infrared (IR) components configured for communication with network 106. Consistent with other embodiments, NIC 202 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Consistent with some embodiments, computing system 200 includes a system bus 204 for interconnecting various components within computing system 200 and communicating information between the various components. Such components include a processing component 206, which may be one or more processors, micro-controllers, graphics processing units (GPUs) or digital signal processors (DSPs), and a memory component 208, which may correspond to a random access memory (RAM), an internal memory component, a read-only memory (ROM), or an external or static optical, magnetic, or solid-state memory. Consistent with some embodiments, computing system 200 further includes a display component 210 for displaying information to a user 120 of computing system 200. Display component 210 may be a liquid crystal display (LCD) screen, an organic light emitting diode (OLED) screen (including active matrix AMOLED screens), an LED screen, a plasma display, or a cathode ray tube (CRT) display. Computing system 200 may also include an input component 212, allowing for a user of computing system 200, such as user A or user B, to input information to computing system 200. An input component 212 may include, for example, a keyboard or key pad, whether physical or virtual. Computing system 200 may further include a navigation control component 214, configured to allow a user to navigate along display component 210. Consistent with some embodiments, navigation control component 214 may be a mouse, a trackball, or other such device. Moreover, if device 200 includes a touch screen, display component 210, input component 212, and navigation control 214 may be a single integrated component, such as a capacitive sensor-based touch screen.

Computing system 200 may further include a location component 216 for determining a location of computing system 200. In some embodiments, location component 216 may correspond to a GPS transceiver that is in communication with one or more GPS satellites. In other embodiments, location component 216 may be configured to determine a location of computing system 200 by using an internet protocol (IP) address lookup, or by triangulating a position based on nearby telecommunications towers or wireless access points (WAPs). Location component 216 may be further configured to store a user-defined location in memory component 208 that can be transmitted to a third party for the purpose of identifying a location of computing system 200. Computing system 200 may also include sensor components 218. Sensor components 218 provide sensor functionality, and may correspond to sensors built into mobile computing device 102 or sensor peripherals coupled to mobile computing device 102. Sensor components 218 may include any sensory device that captures information related to user A and/or mobile computing device 102 that may be associated with any actions that user A performs using mobile computing device 102. Sensor components 218 may include camera and imaging components, accelerometers, biometric readers, GPS devices, motion capture devices, and other devices that are capable of providing information about mobile computing device 102 or user A, or an environment therearound. Computing system 200 may also include one or more wireless transceivers 220 that may each include an antenna that is separable or integral and is capable of transmitting and receiving information according to one or more wireless network protocols, such as Wi-Fi™, 3G, 4G, LTE, RF, NFC, IEEE 802.11a, b, g, n, ac, or ad, Bluetooth®, BLE, WiMAX, ZigBee®, ANT or ANT+, etc.

Computing system 200 may perform specific operations by processing component 206 executing one or more sequences of instructions contained memory component 208. In other embodiments, hard-wired circuitry may be used in place of or in combination with software instructions to implement the present disclosure. Logic may be encoded in a computer readable medium, which may refer to any medium that participates in providing instructions to processing component 206 for execution, including memory component 208. Consistent with some embodiments, the computer readable medium is tangible and non-transitory. In various implementations, non-volatile media include optical or magnetic disks, volatile media includes dynamic memory, and transmission media includes coaxial cables, copper wire, and fiber optics, including wires that comprise system bus 204. Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computing system 200. In various other embodiments of the present disclosure, a plurality of computing systems 200 coupled by a communication link 222 to network 108 (e.g., such as a LAN, WLAN, PTSN, and/or various other wired or wireless networks, including telecommunications, mobile, and cellular phone networks) may perform instruction sequences to practice the present disclosure in coordination with one another. Computing system 200 may transmit and receive messages, data and one or more data packets, information and instructions, including one or more programs (i.e., application code) through communication link 222 and network interface component 202 and wireless transceiver 220. Received program code may be executed by processing component 206 as received and/or stored in memory component 208.

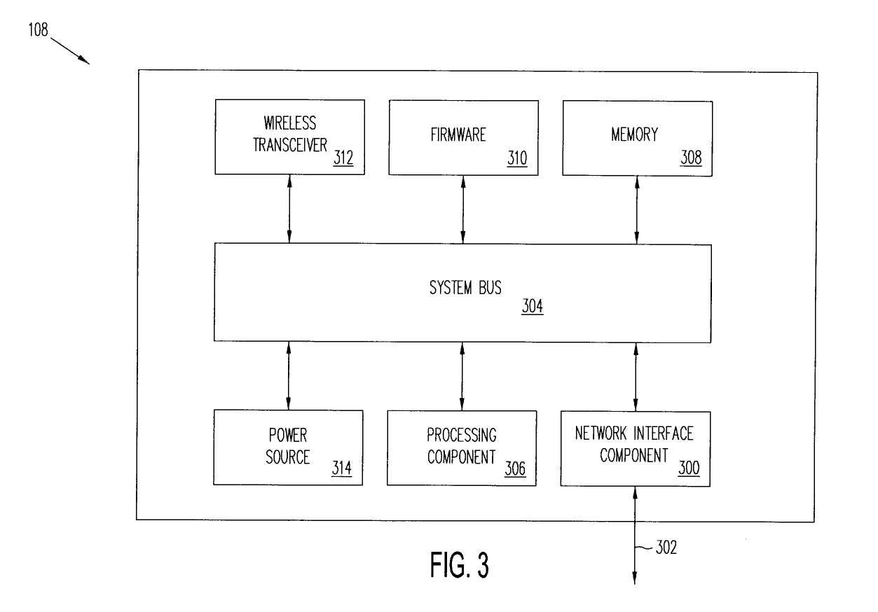

FIG. 3 is a diagram illustrating a beacon 108, consistent with some embodiments. As shown in FIG. 3, beacon 108 includes a network interface component (NIC) 300 configured for communication with a network such as network 106 shown in FIG. 1. Consistent with some embodiments, NIC 300 includes a wireless communication component, such as a wireless broadband component, a wireless satellite component, or various other types of wireless communication components including radio frequency (RF), microwave frequency (MWF), and/or infrared (IR) components configured for communication 302 with network 106. Consistent with other embodiments, NIC 300 may be configured to interface with a coaxial cable, a fiber optic cable, a digital subscriber line (DSL) modem, a public switched telephone network (PSTN) modem, an Ethernet device, and/or various other types of wired and/or wireless network communication devices adapted for communication with network 106.

Beacon 108 also includes a system bus 304 for interconnecting various components within beacon 108 and communicating information between the various components. Such components include a processing component 306, which may be one or more processors, micro-controllers, graphics processing units (GPUs) or digital signal processors (DSPs), a memory component 308, firmware 310 and one or more wireless transceivers 312 that may each include an antenna that is separable or integral and is capable of transmitting and receiving information according to one or more wireless network protocols, such as Wi-Fi™, 3G, 4G, LTE, RF, NFC, IEEE 802.11a, b, g, n, ac, or ad, Bluetooth®, BLE, WiMAX, ZigBee®, ANT or ANT+, etc. In some embodiments, wireless transceivers 312 and network interface component 302 may be part of the same component, or may be separate components. Moreover, network interface component 302 and/or wireless transceivers 312 may also be configured to establish communications with another device using Wi-Fi Direct. In some embodiments, network interface component 302 and wireless transceivers 312 may be capable of communicating with a device based on instructions executed by processing component 306. In other embodiments, network interface component 302 and wireless transceivers 312 may include one or more processors capable of executing instructions for establishing communications and communicating information over an established communication. Beacon 108 may also include a power source 314. Power source 314 may be any power source capable of providing sufficient current to power the components of beacon 108. In some embodiments, power source 318 may be a battery, such as a watch battery or button cell.

In some embodiments, beacon 108 may be configured to transmit information using network interface component 302 and/or wireless transceivers 312 based on instructions stored in memory 308 and/or firmware 310 executed by processing component 306 or by one or more processors in network interface component 302 or wireless transceivers 312. The instructions may be stored in memory 308 and/or firmware 310 by directly writing the instructions to memory 308 and/or firmware 310 over communication link 302 to beacon hardware interface 300 or by wirelessly receiving instructions by wireless transceivers 312. In some embodiments, beacon 108 may also transmit instructions that when received by mobile computing device 102 may cause presence application 116 to be executed by processing component 206 to cause mobile computing device 102 to transmit information identifying itself.

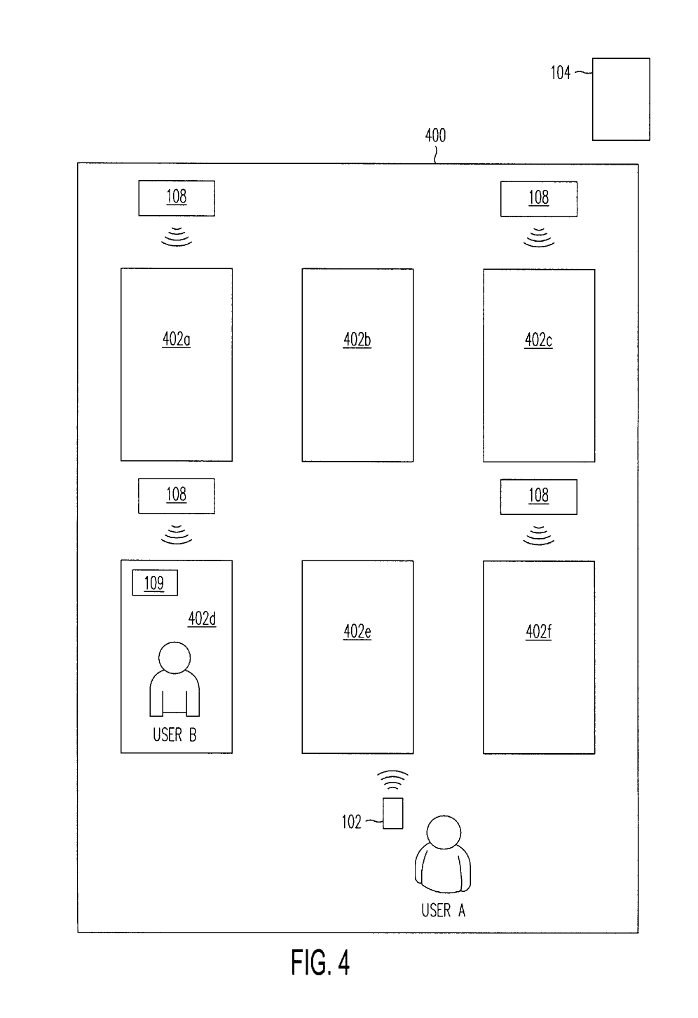

FIG. 4 illustrates in block diagram format an exemplary office or other location 400 and associated system components adapted for restricting content, according to some embodiments. It will be readily appreciated that this particular layout of office or other location 400 is only provided for purposes of illustration, and that many other types of layouts, devices, procedures and the like could be effectively implemented using the various principles of the present disclosure. Location 400 defines a known area that is monitored by beacons 108. Location 400 includes six areas 402, where each area represents, e.g., a cubicle in an office. Areas 402 may also represent hotel rooms in a hotel or any other appropriate feature of the known area represented by location 400.

Location 400 includes a number of beacons 108, wherein some beacons 108 may be coupled to and in communication with a display computing device 109 and/or server 104. These devices can be distributed strategically throughout location 400, such as near the front door, at central locations, at locations 402, and/or at locations of high volume traffic within the establishment. Mobile computing device 102 interacts with one or more of the beacons 108 throughout location 400. Such interaction may include a handshake to establish communications, or may simply include the exchange of information between beacon 108 and mobile computing device 102 using a wireless communications protocol. In some embodiments, only one interaction with beacon 108 may be employed to identify user A and restrict content, although in other embodiments it may be useful to use any number of interactions to determine where user A is located and/or where user A travels and patterns or habits within location 400. Such further information can be used to authenticate the actual user versus one who may have stolen or is otherwise using the mobile device in an unauthorized fashion. Such further authentication can involve checking known user A traffic and patterns against what is currently happening for a given device 102.

When user A having mobile computing device 102 comes within range of a beacon 108, mobile computing device 102 associated with user A may have a low level background program such as presence application 116 running that detects a low level wireless signal from beacon 108. Mobile computing device 102 can then “wake up” and communicate on a more active level with beacon 108 and, for example, complete a handshake or otherwise communicate information. In some embodiments, a device identifier and token can be generated and assigned to mobile computing device 102 for a particular time, location and session, with appropriate expiration and other safeguards in place to protect against fraud or other misuse.

In some embodiments, mobile computing device 102 periodically advertises an identifier that may be used by device 109 or server 104 to retrieve content restrictions associated with user A. For example, beacon 108 may receive the advertised identifier from mobile computing device 102, send the advertised identifier to remote server 104 or device 109 which may access policies at a policy store.

Any beacon 108 in location 400 may also periodically advertise a query for user identities which, when received by mobile computing device 102 causes mobile computing device 102 to respond to the query by providing an identifier. The response from mobile computing device 102 may be sent by beacon 108 to display computing device 109 or server 104.

As user A having mobile computing device 102 moves throughout location 400, mobile computing device 102 may be in communication with other beacons 108. Some beacons 108 may be coupled to and in communication with display computing device 109 and/or server 104 and may be able to communicate with mobile computing device 102 to be able to provide presence information of user A to any appropriate module, such as device 109 and/or server 104. In some embodiments, server 104 and/or display computing device 109 may use received presence data that is related to an area of location 400 at which beacon 108 is located to restrict content. For example, as user A moves around the known space defined by location 400, the location of mobile device 102 can be tracked by, e.g., discerning a relative proximity of device 102 to a particular beacon 108, through assisted GPS, or other technique.

The scope of embodiments is not limited to any particular technique for discerning a location of device 102, and beacons 108 may be placed in location 400 to facilitate tracking of device 102 as appropriate. In one example, user A moves through location 400, and his presence information, including location information, is tracked by device 109, server 104, and/or another device (not shown) as appropriate. Thus, the system is aware that user A is approaching an area proximate display device 109. Either device 109 or server 104 compares the presence information of user A, including location information, to stored policies to determine that documents about Project Mayhem are not to be seen by user A. Display device 109, which is currently displaying a Project Mayhem document, enforces the policy by obscuring the display for as long as user A is within viewing distance of device 109. In another embodiment, display computing device 109 enforces a content restriction policy by switching from a first web page to another web page.

In yet another embodiment, display computing device 109 is a set top box or smart television that enforces content restrictions by allowing some content to be displayed only if it is determined that user A is within a known area. Continuing with the example, a family checks in to a hotel, and the hotel registers device 102 as being able to access adult content on a television within the hotel room. Beacons 108 throughout the hotel allow server 104 and/or device 109 to track the location of user A. If someone requests adult content at device 109, the application content policy directs that request should be denied by server 104 and/or device 109 unless user A's presence information, including location information, indicates that user A is within a viewing area of device 109. The policy may be accessed and compared to presence data by device 109 and/or by server 104.

In yet another embodiment, location 400 is a restaurant or store or other public area. Device 102 is associated with a profile that indicates a preference for one type of content (e.g., family content) over another type of content (e.g., more mature content). As user A moves about location 400, user A's presence, including location, is tracked as described above, via communication with beacons 108. As user A approaches display device 109, display device 109 and/or server 104 compares user A's presence data to a policy and determines that user A prefers one type of content over another type of content. Device 109 and/or server 104 may then stop displaying first content (e.g., a more mature television show) and begin displaying second content (e.g., a family cartoon) in response to the policy and the determined presence of user A. In this particular embodiment, the preference for content is a policy that may be stored at device 102 and advertised to beacons 108. Additionally, or alternatively, the policy may be associated with a user account that is accessed over a network by device 109 and/or server 104. Of course, other use cases are within the scope of embodiments. The use cases outlined above illustrate using presence data and policy data to enforce content restriction, where the presence data is received from or through beacons 108.

The example of FIG. 4 shows a single mobile device and a single display device, but the scope of embodiments is not so limited. Various embodiments may include any number of mobile devices to be tracked, any number of display devices at which to restrict content, and any number of beacons.

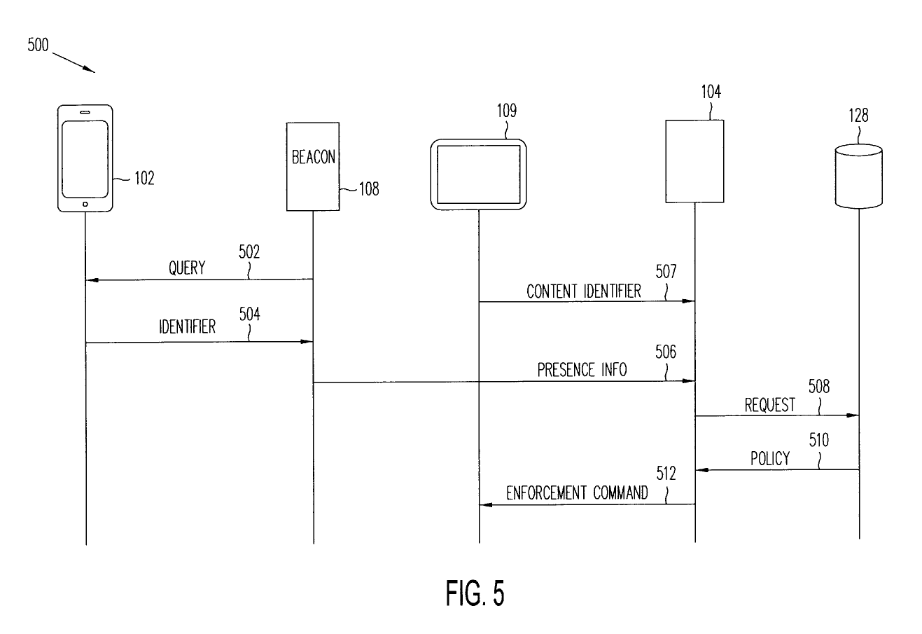

FIG. 5 is a diagram illustrating a first flow 500 for enforcing content restrictions, consistent with some embodiments. As shown in FIG. 5, beacon 108 may send a query 502 to mobile computing device 102 looking for information related to identity of user A. In some embodiments, the query 502 may be sent by beacon 108 periodically looking for any device in range and capable of responding. In some embodiments, the query 502 may be sent by beacon 108 when mobile computing device 102 begins communicating with beacon 108. Mobile computing device 102 may then reply 504 to the query with information that includes, for example, an identification of user A and/or an identification of device 102 that can be matched to a profile of user A. In some embodiments, the communications between beacon 108 and mobile computing device 102 may be performed using a BLE communications protocol or other wireless networking protocol. Moreover, the communications between beacon and mobile computing device 102 may be performed with or without action by user A.

At message 506, beacon 108 may then simply relay the data to server 104 or may apply a more sophisticated approach by determining a location of user A and then passing user A's identity information as well as location information to server 104. In a use case when server 104 receives identity information from beacon 108, server 104 may infer a location of user A by associating user A with a location of the particular beacon 108 sending identifying information.

In some embodiments, the server 104 may use the identity of user A as a search criterion for applicable content restrictions. Server 104 may use the presence information to access a content restriction policy by, e.g., sending request 508 to policy store 128. Policy store 128 returns an applicable policy at message 510, if any, by matching the identity of user A data to one or more policies in the policy store 128 that are associated with user A.

In another embodiment, server 104 uses the identity of requested content as a search criterion for restrictions. For instance, at message 507, display computing device 109 sends an identifier of the content to server 104. Server 104 uses the identity of the content (and perhaps the identity of the user A as well) as a search criterion for content restrictions. In any event, a search of store 128 may produce one or more potentially-applicable restrictions for the user and the content.

Server A compares one or more returned policies to the presence data, which may include location data, to determine an applicable restriction on content associated with the presence of user A. Server 104 then applies the content restriction by sending an enforcement command 512 to display computing device 109.

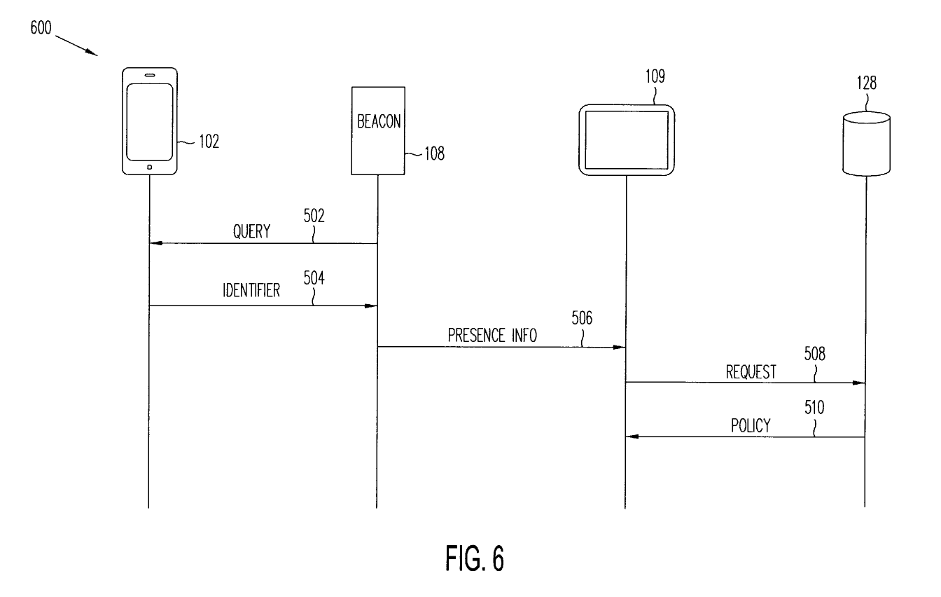

FIG. 6 is a diagram illustrating a second flow 600 for enforcing content restrictions, consistent with some embodiments. Whereas the flow of FIG. 5 places the enforcement logic at server 104, the embodiment of FIG. 6 places enforcement logic at display computing device 109. Communications 502-510 of FIG. 6 are the same as in FIG. 5. Display device 109 enforces the content restriction itself according to the received policies but without receiving an enforcement command from a server.

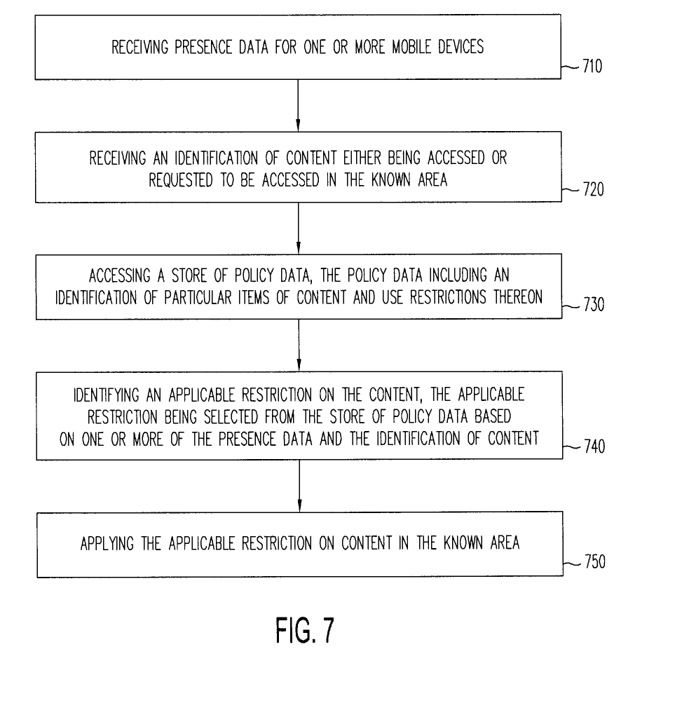

FIG. 7 is a flowchart illustrating a process 700 for providing a enforcement of content restrictions, consistent with some embodiments. For the purpose of illustration, FIG. 7 may be described with reference to any of FIGS. 1-6. Process 700 shown in FIG. 7 may be embodied in computer-readable instructions for execution by one or more processors such that one or more of the steps of the method may be performed by processing component 206 of mobile computing device 102 or server 104.

Action 710 includes receiving presence data for one or more mobile devices. A given mobile device may be associated with a particular user. In one example, presence data is reported by beacons placed within a known area. The presence data identifies a particular mobile device as being within the known area. In some embodiments, the presence data may provide for fine-grained location of the user within the known area, such as proximity to a particular display device or beacon.

Action 720 includes receiving an identification of content either being accessed or requested to be accessed in the known area. In one example, a user is currently viewing a document that has a content restriction. In another example, a user is attempting to access movie, television, or game content. Action 720 may happen before, during, or after action 710 is performed.

Action 730 includes accessing a store of policy data. In this example, the policy data includes an identification of particular items of content and use restrictions thereon. For instance, policy data may indicate a particular class of documents and a security level and/or groups of people allowed access to the document. The policy data may include ratings for television or movie content and restrictions on viewer ages. However, the scope of embodiments includes any type of content and any appropriate restriction thereon.

An example of a policy data store includes a database or file that associates items of content with use restrictions. Such restrictions may also identify users or classes of users, where those users are associated with content and restrictions. In other words, some embodiments may include allowing the identity of a user as a searching key for applicable rules. Other embodiments may allow for searching by restriction, content, or other information.

Some restrictions may be positively recited, e.g., stating that certain users are allowed to access the content, where it is understood that users other than the certain users are not allowed to access the content. By contrast, some restrictions may be negatively stated, e.g., identifying users who are not allowed to access the content, where it is understood that users other than the excluded users are allowed to access the content. The policy data store may be local to the computer device that is accessing the policy data or may be remote therefrom. In other embodiments, the policy data may be included as metadata within the content itself. Examples include metadata in a file defining who may access the file and embedded rating information in movies, television shows, and games.

Action 740 includes identifying an applicable restriction on the content. For example, the applicable restriction may be selected from the store of policy data based on the presence data and/or the identification of content. Some examples include receiving more than one restriction and selecting one or more of the received restrictions based on an identity of the user, a location of the user, and/or the identification of the document.

Action 750 includes applying the applicable restriction on content in the known area. An example restriction may include disallowing viewing or access of a document by the user from action 710. Another example restriction may include denying access to content unless the user from action 710 is determined to be present in the known area. Any applicable restriction may be employed in various embodiments.

According to the use case described above in which user B is viewing a sensitive network document as user A approaches user B's computer, action 750 may include altering a current display of the document in real time in response to determining that user B is not allowed to view the network document.

According to the use case described above in which a particular user must be in a room for certain content to be displayed on a television, action 750 may include allowing a display of television content in response to determining that the particular (and present) user is approved to view the television content.

According to the use case described above in which a user enters a public area having a profile indicating a preference for one type of content over another type of content, action 750 may include interrupting a display of first television content and allowing a display of second television content in response to determining that the user prefers to view the second television content but does not prefer to view the first television content. In such a use case, the system may identify and select the second content in response to the restriction and/or in response to determining that user A is present in the area of the display.

According to the use case described above in which user B is viewing a web page and restricts the web page from being viewed by user A, action 750 may include switching a display from the first web page to a second web page, when determining that user A is approaching a vicinity of user B.

The scope of embodiments is not limited to the specific series of actions shown in FIG. 7. Rather, other embodiments may rearrange, modify, omit, or add actions. For instance, in one example, a system continually applies usage restrictions as content is accessed, or attempted to be access, and as persons move about the known area or enter/leave the known area. Furthermore, method 700 may further include creating and saving new restrictions, such as receiving input indicating that user A should not view certain content and saving the input to the store of policy data.

Other embodiments may further include setting the policies. Any appropriate entity may set policies to restrict content. For instance, the creator of a document, administrator of a document storage system, or user (e.g., user B in FIG. 1) may restrict a document. Such restrictions may be set by adding metadata to a document setting for the policy, inputting the restrictions into a document retrieval or editing application (e.g., a word processing application), or other techniques. With respect to television, movie, and game content, a parent or content creator may set restrictions. Restrictions may be set by placing metadata in the content (e.g., ratings information placed in television content), inputting restriction information into a program that access the content (e.g., by programming a set top box) or other techniques. The scope of embodiments is not limited to any particular technique to set restrictions nor to any particular restrictions. Examples of additional restrictions that may be enforced by some embodiments include date and/or time based restrictions, such that certain content can only be viewed during certain times, such as during work hours, by authorized users.

Software, in accordance with the present disclosure, such as program code and/or data, may be stored on one or more machine-readable mediums, including non-transitory machine-readable medium. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A system, comprising:
a transceiver;
a memory storing instructions; and
one or more processors in communication with the transceiver and the memory, the one or more processors configured to execute the instructions to cause the system to:
receive presence data for a user associated with an electronic mobile device, where the presence data indicates a location of the user in a known area;
receive an identification of content either being accessed or requested to be accessed in the known area;
access a store of policy data, the policy data including an identification of particular items of content and use restrictions thereon;
identify an applicable restriction on the content, the applicable restriction being selected from the store of policy data based on one or more of the presence data and the identification of content; and
apply the applicable restriction on the content.

2. The system of claim 1, wherein the transceiver is configured to send and receive information according to the Bluetooth® Low Energy (BLE) communications protocol.

3. The system of claim 1, further comprising a display apparatus in communication with the processor to display the content in accordance with the applicable restriction.

4. A method comprising:
receiving, by a computer system, presence data for a user associated with an electronic mobile device, where the presence data indicates that the user is present in a known area;
receiving, by the computer system, an identification of content;
accessing, by the computer system, a store of policy data, the policy data including an identification of particular items of content and use restrictions thereon;
selecting, by the computer system, a first restriction on the content, the first restriction being selected from the store of policy data based on one or more of:
an association of the first restriction with the user; and
the identification of content; and
applying, by the computer system, the first restriction on the content

5. The method of claim 4, wherein the policy data comprises an access restriction on a network document, further wherein applying the first restriction comprises:
altering a current display of the document in real time in response to determining that the user is not allowed to view the network document.

6. The method of claim 4, wherein the policy data comprises an access restriction to specific media content ratings, further wherein applying the first restriction comprises:
allowing a display of media content in response to determining that the user is approved to view the television content.

7. The method of claim 4, wherein the policy data comprises an access restriction to specific television content ratings, further wherein applying the first restriction comprises:
interrupting a display of first television content and allowing a display of second television content in response to determining that the user prefers to view the second television content and does not prefer to view the first television content.

8. The method of claim 7, further comprising:
identifying the second television content in response to the first restriction.

9. The method of claim 4, wherein the store of policy data includes metadata in the content itself, the content including a document.

10. The method of claim 4, wherein the particular items of content include at least one of:
television content with a rating;
movie content with a rating;
gaming content with a rating; or
a document marked with an access restriction.

11. The method of claim 4, wherein applying the first restriction comprises:
switching a display from a first web page to a second web page in response to the first restriction indicating that the user should not view the first web page.

12. The method of claim 4, further comprising:
receiving input indicating that the user should not view the content; and
saving the input to the store of policy data.

13. A computer program product having a computer readable medium tangibly recording computer program logic for enforcing content restrictions, the computer program product comprising:
code to receive presence data for a user, where the presence data indicates a location within a known area of an electronic device of the user;
code to receive an identification of content either being accessed or requested to be accessed;
code to access content policy data, the content policy data associating particular items of content with respective use restrictions;
code to identify a first restriction associated with the content, the first restriction being selected from the content policy data based on one or more of the presence data and the identification of content; and
code to apply the first restriction to the content.

14. The computer program product of claim 13, wherein the content policy data comprises an access restriction on a network document, further wherein the code to apply the first restriction comprises:
code to alter a current display of the document in real time in response to determining that the user is not allowed to view the network document.

15. The computer program product of claim 13, wherein the content policy data comprises an access restriction to specific television content ratings, further wherein the code to apply the first restriction comprises:
code to allow a display of television content in response to determining that the user is approved to view the television content.

16. The computer program product of claim 13, wherein the content policy data comprises an access restriction to specific media content ratings, further wherein the code to apply the first restriction comprises:
code to interrupt a display of first media content and allow a display of second media content in response to determining that the user prefers to view the second media content and does not prefer to view the first media content.

17. The computer program product of claim 13, wherein the code to apply the first restriction comprises:
code to switch a display from a first web page to a second web page in response to the first restriction indicating that the user should not view the first web page.

18. The computer program product of claim 13, wherein the content policy data includes metadata in the content itself, the content including a document.

19. The computer program product of claim 13, wherein the particular items of content include at least one of:
television content with a rating;
movie content with a rating;
gaming content with a rating; or
documents marked with an access restriction.

20. The computer program product of claim 13, further comprising:
code to receive input indicating that the user should not view the content; and
code to save the input to the store of policy data.
